(19) United States
(12) Patent Application Publication
(10) Pub. No.: US 2017/0087645 A1
(43) Pub. Date: Mar. 30, 2017

(54) END MILL

(71) Applicant: HAIMER GMBH, Igenhausen (DE)

(72) Inventors: Franz Josef HAIMER, Igenhausen (DE); Reinhold SANHIETER, Hohenwart (DE)

(73) Assignee: HAIMER GMBH, Igenhausen (DE)

(21) Appl. No.: 15/279,520

(22) Filed: Sep. 29, 2016

(30) Foreign Application Priority Data
Sep. 30, 2015 (DE) 10 2015 116 624.0

(51) Int. Cl. B23C 5/10

(52) U.S. Cl. CPC B23C 5/10; B23C 2210/202; B23C 2210/203; B23C 2210/204; B23C 2210/54; B23C 2210/282; B23C 2240/32

(57) ABSTRACT

An end mill, preferably made of solid carbide, with a fastening section and a cutting area, in which the cutting area is formed by a core and three, four or five cutting edges arranged around core and running helically around the axis of rotation of the end mill, each one of which has a peripheral main cutting edge and a secondary cutting edge on the face of cutting area. In order to create an end mill simple to manufacture and optimized for drilling, at least one cutting edge on the face of cutting area has a single, flat or continuously curved front surface, which delimits the cutting edge in the longitudinal direction of the mill on face.

### FIELD OF THE INVENTION

The invention concerns an end mill for chip removal of metallic materials, especially steel and titanium.

### BACKGROUND

An end mill having a fastening section and a cutting area, is known from DE 37 06 282 A1. The cutting area is formed by a rotationally symmetric core and four cutting edges, which are arranged helically around the core and joined in one piece to the core. The four cutting edges each have a peripheral main cutting edge and a secondary cutting edge on a free face of the cutting area in order to make possible chip removal in both peripheral and face milling. A situation is thereby achieved in which, in addition to peripheral milling with the face of the solid carbide end mill, surface milling operations can also be conducted. However, there is the drawback that such end mills are not suitable for drilling, i.e., chip removal with the secondary cutting edges at an advance direction along the axis of rotation of the end mill, since the secondary cutting edges often do not have the desired stability and service life. In addition, the geometry of both the secondary cutting edges and the chip grooves on the face of the milling cutter are not suitable for drilling, since the cutting function is not guaranteed in the center area and the chips cannot be ejected laterally during drilling. Commercial milling cutters are not suitable or only marginally suitable for axial chip removal during drilling, i.e., along the chip grooves, since the chip spaces clog too quickly.

### SUMMARY OF THE INVENTION

At least some of the embodiments of the invention relate to an end mill that is easy to produce and optimized for drilling.

Advantageous embodiments of the invention are also disclosed.

It is first clarified that a fastening section of the end mill need not necessarily be designed as a cylindrical holding section. Other types of fastening section or coupling sites are contemplated by the present invention. Any type of coupling site can be understood under the term “shank” with which the cutting section is joined to a separate toolholder. The coupling site, for example, can also be conical, carry threads or include clamping surfaces. The holding section can even be designed as a hole in the cutting area, which is accommodated on a complementary pin of the toolholder.

Solid carbide milling cutters are understood to mean milling cutters in which the chip-removing cutting edges are a fixed component of the tool body. All cutting materials suitable for machining of high-strength materials are to be understood as base material of this cutter, i.e., ceramic materials, PCD and powder mixtures, in addition to steels.

Preferably, end mills according to the invention have at least one cutting edge on the face of the cutting area has a single, flat or continuously curved front surface (or relief angle), which delimits the cutting edge in the longitudinal direction of the end mill on the face. Through this precisely one front surface on each cutting edge on the face of the cutting area, a single free surface is formed, which is particularly stable relative to multiple free surfaces with different relief angles and permits stability in heat removal suitable for special requirements of drilling and also milling with the end mill. Due to the one front surface, such an embodiment is also easy to manufacture and subsequently grind as required, since only one surface need be machined with an angle.

In addition, the end mill, despite “drilling-optimized” geometry, is characterized by excellent milling performance with quiet running. The special geometry also proves to be very robust for milling. Intensive research and studies with milling experiments have shown that the milling cutters from the prior art do not function universally enough in different materials. The end mill according to the invention is characterized by high universal applicability and milling performance in a wide variety of materials and applications, for example, roughening and finishing, ramping, plunge milling and grooving.

In an advantageous embodiment the front surface of each cutting edge on the secondary cutting edge has a relief angle between 5° and 7°, especially equal to 6°, relative to a plane perpendicular to the axis of rotation of the end mill. A particularly stable secondary cutting edge with high removal performance and long service life can thereby be achieved, especially together with the described precisely one front surface of the cutting edges on the face.

In considering the front face of the cutting area of the end mill, each at least one secondary cutting edge can also have at least one curved, especially concave, trend at least in sections, so that particularly advantageous chip removal is achieved in conjunction with the aforementioned features.

At least one secondary cutting edge can preferably have a protruding center distance in the radially outer area. A protruding center distance is characterized by the fact that the at least one secondary cutting edge is designed so that it extends beyond an imaginary connection of the end point lying closest to the face of the main cutting edge, i.e., the transition from the main to the secondary cutting edge, with the center in the direction of rotation. Simply put, this means that both cutting edges are in front of the axis of rotation and their cutting edges do not meet at the tips in the direction of the center but partially overlap.

In particular, in order to increase the cutting performance of the secondary cutting edge during drilling, it can be prescribed that a point thinning of the core be provided between two adjacent cutting edges on the face of the cutting area, which has an angle from 30° to 40° relative to the axis of rotation of the end mill. Through this sharp point thinning of the core between two adjacent cutting edges, particularly good chip removal is made possible, in which case the cutting edges in the area of the face of the cutting area have high stability despite point thinning of the core.

Point thinning according to the invention embraces any embodiment with which the material of the core and possibly also the cutting edges in the area of the face of the cutting area is locally reduced in the peripheral direction between the cutting edges. The rotationally symmetrical core area of an end mill in the cutting area is to be understood as core. The cutting edges are arranged around this core and made in one piece with the core. The bottom of each chip removal groove, which is formed in the peripheral direction between the cutting edges, is then bounded by the core.

With particular preference, the point thinning can be designed as a recess in the area of the face of the cutting area approaching the axis of rotation of the end mill in the direction from the fastening section to the face of the cutting area. Such a recess can be achieved particularly simply by grinding.

In order to permit chip removal on the entire face during drilling by at least one secondary cutting edge, the recess can also extend in the radial direction of the cutting area essentially up to the axis of rotation of the end mill and delimit the secondary cutting edge in the area of the axis of rotation of the end mill.

The cutting edges in a particularly advantageous embodiment are unevenly distributed at least on the face of the cutting area. The stability of the cutting edges can thereby be increased, since cutting edges with a small intermediate angle can have a mutually stabilizing effect. In order to reduce the tendency toward vibration, the cutting edges can also have different helix angles so that the cutting edges can also be arranged equally distributed at least in sections in the cutting area outside of the face.

It can be particularly advantageous that the cutting area have a total of four cutting edges, of which a first cutting edge and a third cutting edge are diametrically opposite each other, as are a second cutting edge and a fourth cutting edge, in which case point thinning is provided between the second cutting edge and the third cutting edge, as well as between the first cutting edge and the fourth cutting edge, and in the peripheral direction of the cutting area the angle between the first cutting edge and the fourth cutting edge and between the second cutting edge and the third cutting edge is greater than 90° and less than 110°, especially equal to 100°. This ensures that, despite the sharp point thinning between the second cutting edge and the third cutting edge, as well as the first cutting edge and the fourth cutting edge, the cutting edges are mutually supported by the smaller angular distance between the first cutting edge and the second cutting edge and between the third cutting edge and the fourth cutting edge, so that high stability is thereby achieved. The end mill is therefore particularly suited for drilling even in materials that are difficult to machine. This permits a particularly stable secondary cutting edge to be created with high removal performance and long service life and to ensure chip removal, especially together with the described point thinning and the precisely one front surface of the cutting edge on the face.

In order to further increase the drilling performance of the end mill and facilitate chip removal, an additional point thinning can be provided between the first cutting edge and the second cutting edge and between the third cutting edge and the fourth cutting edge, which has an angle from 20 to 40° relative to the axis of rotation of the end mill.

It can also be particularly advantageous for drilling performance if the cutting edges have a hollow grinding on the face of the cutting area, i.e., the secondary cutting edges on the face protrude radially outwards in the direction from the axis of rotation in the longitudinal direction of the cutting area so that the front surface has a concave configuration.

In order additionally to improve the chip removal performance, it can be prescribed that the core of the cutting area have two conical sections with different conicity. Starting from the face of the cutting area, a first conical part can be provided, which widens from a diameter corresponding to 35-45% of the cutting area diameter to a diameter corresponding to 45-60%, preferably 50-55% of the cutting area diameter. This first conical part can extend in the longitudinal direction of the cutting area over a length of 0.25 times to the entire length of the area diameter. A second conical area can follow this first conical part, which widens along the useful cutting area to 50-70%, preferably 55% of the cutting area diameter. The first conical area is always designed so that it has a greater slope than the second conical area and the diameter of the first conical area does not become greater than the diameter of the second conical area.

The milling cutter according to the invention can additionally be provided in the fastening section with protrusions for a limit stop, for example, in the form of a Weldon or Whistle-notch surface or also in the form of a blocking groove starting on the shank side, as described in WO 2007118626 A1, or in the form of a blocking element protruding from the fastening section.

### BRIEF DESCRIPTION OF THE DRAWINGS

Additional details and advantages of the invention are apparent from the following description of a preferred embodiment example with reference to the drawings. In the drawings:

FIG. 1 shows a side view of a solid carbide end mill with a cutting area and a fastening section;

FIG. 2 shows a detail view of a solid carbide end mill from FIG. 1 in the area of a free face of the cutting area;

FIG. 3 shows a cross-sectional view of the solid carbide end mill of FIG. 1 along cutting line C-C;

FIG. 4 shows a front view of the free face of the solid carbide end mill from FIG. 1;

FIG. 5 shows a cross-sectional view of the solid carbide end mill in the area of the free face of the cutting area along cutting line D-D of FIG. 4;

FIG. 6 shows a cross-sectional view of the solid carbide end mill in the area of the free face of the cutting area along cutting line E-E of FIG. 4;

FIG. 7 shows a detail view of area X of FIG. 4;

FIG. 8 shows a side view of the solid carbide end mill of one version of the core of the cutting area;

FIG. 9 shows a side view of an additional embodiment example of the solid carbide end mill in the form of a screw-in milling cutter;

FIG. 10 shows a front view of the free face of the solid carbide end mill from FIG. 9;

FIG. 11 shows a cross-sectional view of the solid carbide end mill in the area of the free face of the cutting area along cutting line F-F of FIG. 10;

FIG. 12 shows a cross-sectional view of the solid carbide end mill in the area of the free face of the cutting area long cutting line G-G of FIG. 10 and

FIG. 13 shows a detail view of area X2 of FIG. 10.

### DETAILED DESCRIPTION

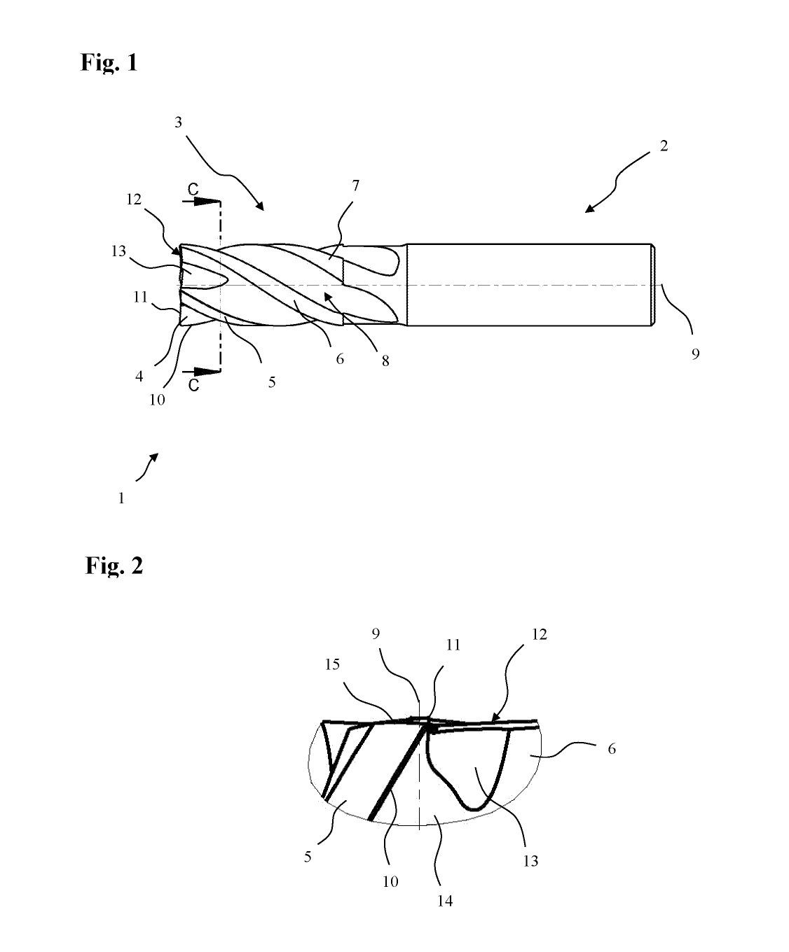

A solid carbide end mill 1 is shown in a side view in FIG. 1. The solid carbide end mill 1 has a fastening section 2 and a cutting area 3 with four cutting edges 4, 5, 6 and 7. The fastening section 2 has a cylindrical shape and is designed for mounting in a chuck (not shown) of a workpiece machining tool, for example, a CNC milling machine. The cutting area 3 is connected to the fastening section 2, which is formed by a core 8 and the cutting edges 4, 5, 6 and 7 arranged around core 8. The cutting edges 4, 5, 6 and 7 run helically about an axis of rotation 9 of the solid carbide end mill 1 and are formed in one piece with core 8.

Each cutting edge 4, 5, 6 and 7 has a peripheral main cutting edge 10 and a secondary cutting edge 11 on a face 12 of the cutting area 3, which are designed to cooperate with the workpiece being machined during rotation of the solid carbide end mill 1 around axis of rotation 9. For better clarity the reference numbers for the main cutting edge 10 and the secondary cutting edge 11 in the depiction in the figures are not entered for all cutting edges 4, 5, 6 and 7, but each cutting edge 4, 5, 6 and 7 has both a main cutting edge 10 and a secondary cutting edge 11.

Point thinning 13 of core 8 is also provided at least in the area of face 12 of cutting area 3.

The core 8 in the peripheral direction of the solid carbide end mill 1 is reduced in cross section by this point thinning 13 locally delimited between the cutting edges 5 and 6.

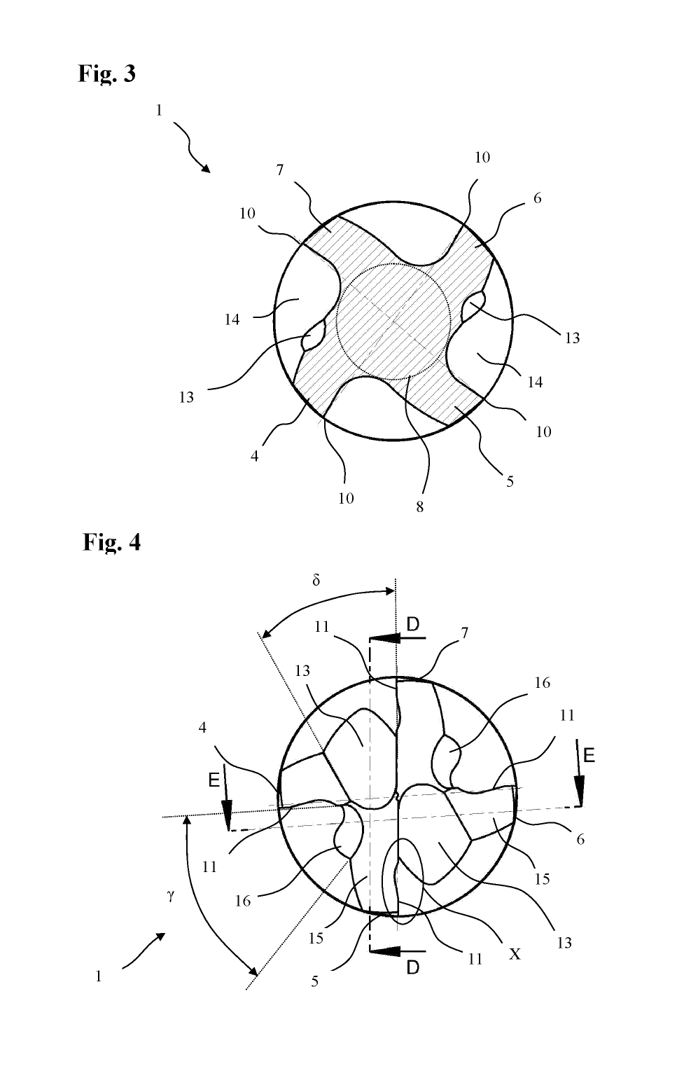

The solid carbide end mill 1 from FIG. 1 is depicted in FIG. 2 in a detail view in the area of the face 12 of the cutting area 3. As can be deduced from FIG. 2, the point thinning 13 is designed as a recess, produced, for example, by grinding in the area of the face 12 of the cutting area 3 in a chip removal groove 14 between the two cutting edges 5 and 6, which approaches the axis of rotation 9 of the solid carbide end mill 1 in the direction from the fastening section 2 to the face 12 of the cutting area 3. The chip removal groove 14 is arranged between each of the cutting edge 4, 5, 6 and 7 and serves to remove chips produced by the main cutting edges 10 and the secondary cutting edges 11 of the cutting edges 4, 5, 6 and 7. The cross section of the chip removal grooves 14 in the area of face 12 of cutting area 3 is increased by the point thinning 13 so that chips can be transported away particularly well especially from the area of the secondary cutting edges 11 close to the center.

The cutting edge 5 depicted in FIG. 2, like the other cutting edges 4, 6 and 7, has a relief angle 24 from 5° to 7° and especially 6°, which means the angle between a front surface 15 of each secondary cutting edge 11 and a plane perpendicular to axis of rotation 9 amounts to 5° to 7°, especially 6°.

As can also be seen, the cutting edges 4, 5, 6 and 7 have a hollow grinding on face 12 of the cutting area 3, which means that the cutting edges 4, 5, 6 and 7 and therefore especially the secondary cutting edges 11 on face 12 protrude radially outward in the longitudinal direction of the cutting area 3 in the direction from axis of rotation 9 so that the front surface 15 has a concave configuration.

A cross section of the solid carbide end mill 1 is shown in FIG. 3 along line C-C of FIG. 1. As can be deduced there with reference to the dash-dotted lines drawn as an aid, the cutting edges 4, 5, 6 and 7 together with the main cutting edges 10 are arranged unevenly distributed in the peripheral direction of the solid carbide end mill 1. Thus, a first cutting edge 4 and a third cutting edge 6, as well as a second cutting edge 5 and a fourth cutting edge 7, lie diametrically opposite each other against the peripheral direction of the cutting edges 4, 5, 6 and 7, i.e., clockwise in FIG. 3, but the angle between the first cutting edge 4 and the subsequent fourth cutting edge 7 and between the third cutting edge 6 and the subsequent second cutting edge 5 is made greater than 90°, with particular preference precisely 100°. This means that the angle between the third cutting edge 6 and the fourth cutting edge 7, as well as between the first cutting edge 4 and the second cutting edge 5, is therefore less than 90° and preferably precisely 80°.

The cutting edges 4, 5, 6 and 7 extend in the peripheral direction on their outside roughly over a length corresponding to 0.1 to 0.2 times the diameter of the cutting area 2 (cutting area diameter).

The point thinning 13 is provided between the second cutting edge 5 and the third cutting edge 6, as well as between the fourth cutting edge 7 and the first cutting edge 4. The cross section of the cutting area 3 and especially the first cutting edge 4 is reduced by the point thinning 13 in the chip removal groove 14 between the fourth cutting edge 7 and the first cutting edge 4, and of the third cutting edge 6 in the chip removal groove 14 between the second cutting edge 5 and the third cutting edge 6. Because of the reduced angle described above between the first cutting edge 4 and the second cutting edge 5, as well as between the third cutting edge 6 and the fourth cutting edge 7, a situation is achieved in which the stability of the first cutting edge 4 and the third cutting edge 6 is not reduced due to the spatial proximity to the second cutting edge 5 and the fourth cutting edge 7. In the area close to the face 12 of the cutting area 3 the cross section of the circular core 8 depicted in cross section by means of the dotted line in FIG. 3 is also reduced by the point thinning 13, as follows from the subsequent figure.

A front view of the free face 12 of the cutting area 3 of the solid carbide end mill 1 is shown in FIG. 4. As also already indicated in the cross-sectional view of FIG. 3, the cutting edges 4, 5, 6 and 7 are unevenly distributed on the face 12 of the cutting area. Since the helix angle of the cutting edges 4, 5, 6 and 7 in the depicted embodiment example is constant over the length of the entire cutting area 3, the angles between the cutting edges 4, 5, 6 and 7 on the face 12 correspond to those shown in FIG. 3 and the angle between first cutting edge 4 and the second cutting edge 5, as well as between the third cutting edge 6 and the fourth cutting edge 7, is consequently less than 90°, especially 80°, in which case the first cutting edge 4 and the third cutting edge 6, as well as the second cutting edge 5 and the fourth cutting edge 7, are diametrically opposite each other. This unequal division of cutting edges 4, 5, 6 and 7 is of special significance in the area of face 12 of cutting area 3 and especially in cutting area 3, since here the reduction of the cross section of core 8 of the solid carbide end mill 1 is most strongly pronounced through the point thinning 13 in order to form and delimit the two secondary cutting edges 11 extending essentially to the axis of rotation 9, as well as permitting chip removal from the secondary cutting edges 11 in the axial direction close to the axis of rotation 9. This is of particular significance in drilling, since material must be removed over the entire cross section of the cutting area 3 during drilling in solid material without predrilling. The point thinning 13 is designed so that it extends to the axis of rotation 9 on the face 12 of the cutting area 3 to an extent that corresponds to 0.005 to 0.015 times the cutting area diameter. In the radial direction the point thinning 13 on the face 12 of cutting area 3 extends over a length corresponding to 0.575 to 0.75 times the cutting area diameter. In addition, the flanks of the point thinning 13 in the top view depicted in FIG. 4 run toward each other on the face 12 at an angle δ of 30° to 45° in perspective view, the tip being rounded in the direction of axis of rotation 9 with a radius corresponding to 0.075 to 0.125 times the cutting area diameter.

As can be deduced from FIG. 4, an additional point thinning 16 is provided between the first cutting edge 4 and the second cutting edge 5, as well as between the third cutting edge 6 and the fourth cutting edge 7, which, like each point thinning 13, is formed as a recess in the area of the face 12 of the cutting area, generated, for example, by grinding and approaching the axis of rotation 9 of the solid carbide end mill 1 in the direction from the fastening section 2 to the face 12 of the cutting area 3. The additional point thinning 16 then reduces both the cross section of core 8 of cutting area 3 and also the cross section of the second cutting edge 5 in the chip removal groove 14 between the first cutting edge 4 and the second cutting edge 5 and the cross section of the fourth cutting edge 7 in the chip removal groove 14 between the third cutting edge 6 and the fourth cutting edge 7. As can be deduced from FIG. 4 and as described further with reference to the subsequent figures, each additional point thinning 16 is formed less sharply than each point thinning 13 in order not to weaken the coherence of the first cutting edge 4 with the second cutting edge 5 and the third cutting edge 6 with the fourth cutting edge 7. The additional point thinnings 16 extend in the direction of the secondary cutting edges 11 of the second cutting edge 5 and the fourth cutting edge 7, when viewed from the face 12 of the cutting area 3, to a distance corresponding to 0.1 to 0.2 times the cutting area diameter. In addition, each additional point thinning 16 is rounded in the direction of the axis of rotation 8 with a radius corresponding to 0.1 to 0.3 times the cutting area diameter. In addition, the flanks of the point thinning 16 in the top view depicted in FIG. 4 run toward each other at an angle γ that can assume a value from 30° to 45° in the perspective view.

As already indicated, the described unequal division of cutting edges 4, 5, 6 and 7 in the area of face 12 of cutting area 3 is of special significance for the stability of the cutting edges 4, 5, 6 and 7 in conjunction with the design of the point thinning 13 and the additional point thinning 16. Differently than described with reference to FIG. 3, the unequal division of cutting edges 4, 5, 6 and 7 in the cutting area 3 can vary along the axis of rotation 9, for example, by different helix angles of the cutting edges 4, 5, 6 and 7 so that an equal division of the cutting edges 4, 5, 6 and 7 can also be present in a cross section outside face 12.

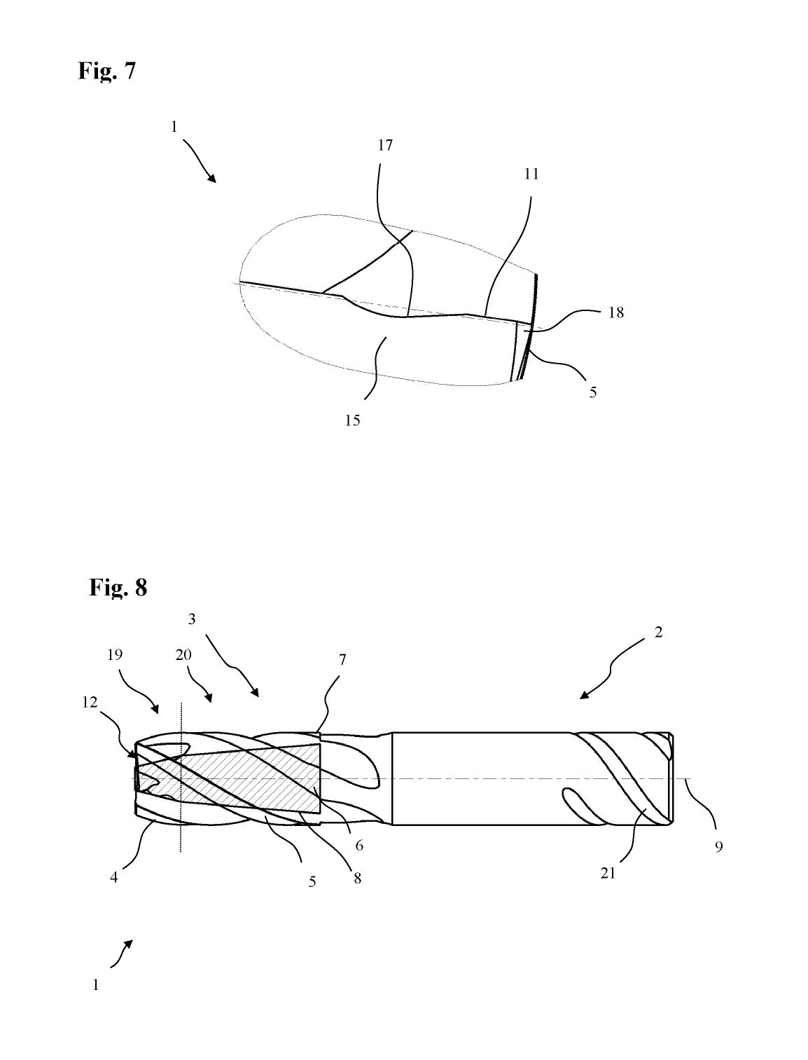

As can also be deduced from FIG. 4, each cutting edge 4, 5, 6 and 7 on the face 12 of the cutting area 3 is delimited by a single flat front surface 15 in the longitudinal direction of the solid carbide end mill 1, i.e., in the direction of the axis of rotation 9 on face 12. As already explained, the relief angle of the secondary cutting edge 11 is between 5° and 7° and especially precisely 6°. However, it is also possible to form this front surface 15 continuously curved. In this case this angle of the curved face 12 is increased, starting from the relief angle on each secondary cutting edge 11. Each secondary cutting edge 11 also has a trend that is curved relative to an axis across the axis of rotation, as further explained, in particular, with reference to FIG. 7. A straight trend, however, is also possible. As can also be deduced from FIG. 4, the opposite point thinnings 13 overlap beyond the axis of rotation 9 by 0.075 times to 0.25 times the cutting area diameter.

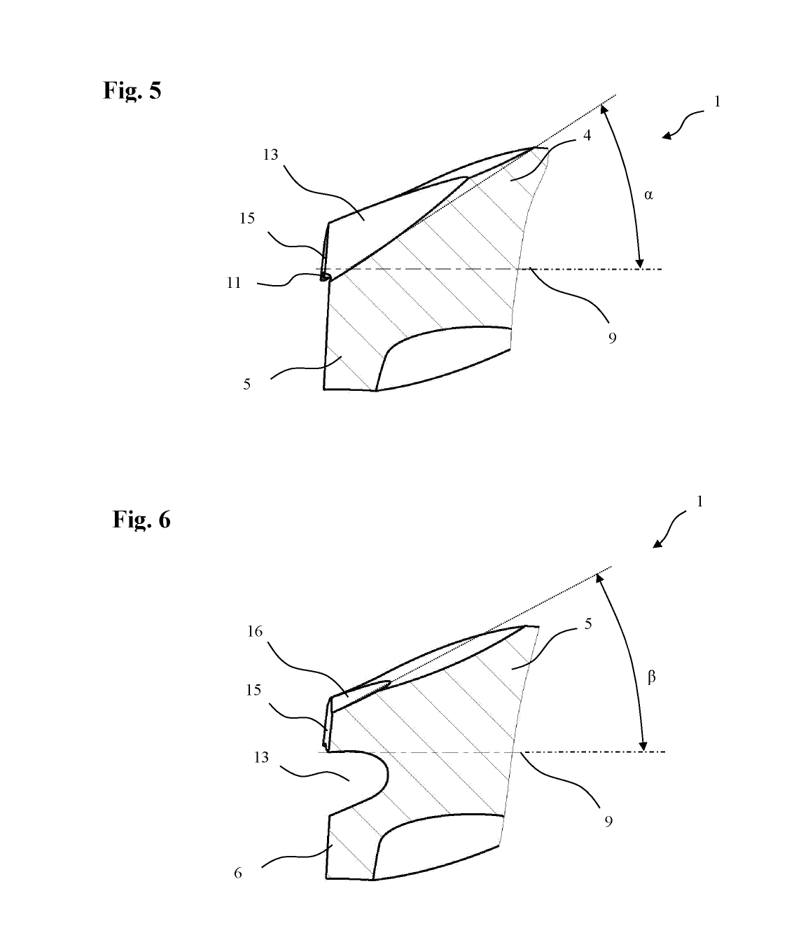

A cross-sectional view through the solid carbide end mill 1 in the area of face 12 of the cutting area 3 is shown in FIG. 5 along line D-D of FIG. 4. This section D-D runs eccentrically through the first cutting edge 4 with the point thinning 13 between the fourth cutting edge 7 and the first cutting edge 4, as well as through the second cutting edge 5. The point thinning 13 then runs along the dotted line introduced as an aid at an angle α from 30° to 40° relative to the axis of rotation 9. The angle α is the angle of the point thinning 13. The extent of the point thinning 13 in the direction of axis of rotation 9 then has a length corresponding to 0.2 to 0.5 times the cutting area diameter.

A cross-sectional view through the solid carbide end mill 1 is shown in FIG. 6 in the area of the face 12 of the cutting area 3 along line E-E of FIG. 4. This section E-E runs eccentrically through the second cutting edge 5 with additional point thinning 16 between the first cutting edge 4 and the second cutting edge 5, as well as through the third cutting edge 6. As is apparent, the additional point thinning 16 then runs along the dashed line shown as an aid at an angle β from 20° to 40° relative to axis of rotation 9. The addition point thinning 16 then does not extend in the radial direction beyond the axis of rotation 9, unlike each point thinning 13, and the radial extent is consequently less than 0.5 times the cutting area diameter. The angle β is the angle of point thinning 16. The angle of each point thinning 13 and each additional point thinning 16 relative to axis of rotation 9 can then be made equal or different.

A detail view of area X of FIG. 4 is shown in FIG. 7. As can be seen there, the secondary cutting edge 11 of the second cutting edge 5, like each additional cutting edge 4, 6 and 7, has a bulge 17 when viewed from the face 12 of the cutting area 3 with a curved, especially concave trend. Because of this, especially in conjunction with the aforementioned features, particularly advantageous chip removal and therefore advantageous chip removal during drilling operations is achieved. The bulge 17 then begins at a distance from the axis of rotation 9 corresponding to 0.2 to 0.35 times the cutting area diameter and extends in the radial direction over a length corresponding to 0.1 to 0.25 times the cutting area diameter. The radius of the bulge 17 amounts to 0.1 to 0.25 times the cutting area diameter.

The center line of the secondary cutting edge 11 that runs through the axis of rotation 9 is indicated by the dash-dot line in FIG. 7. The bulge 17 then has a spacing from the center line that corresponds to 0 to 0.015 times the cutting area diameter and the remaining linear part of the secondary cutting edge is spaced from the center line by a length that extends from 0.002 times the cutting area diameter against the peripheral direction of the second cutting edge 5 to 0.01 times the cutting area diameter in the peripheral direction of the second cutting edge 5. This distance from the center line is the protruding center distance. Since the transition along the secondary cutting edge goes beyond the corner chamfer 18, an additional chamfer is formed between the corner chamfer and the main cutting edge.

As can be further deduced from the detail view in FIG. 7, a corner chamfer 18 is provided between the secondary cutting edge 11 in the main cutting edge 10 so that better heat removal and a longer service life as well as better centering of the solid carbide end mill 1 is achieved during drilling operations.

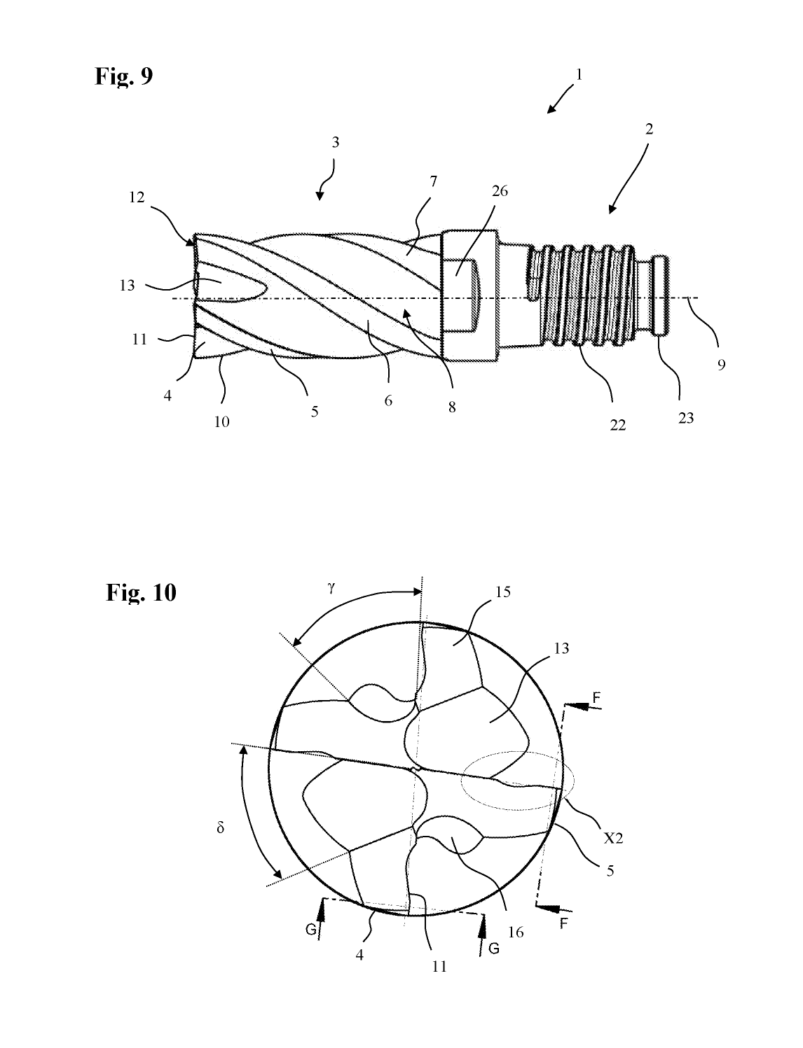

A side view of the solid carbide end mill 1 with a schematic depiction of the core 8 of the cutting area 3 is shown in FIG. 8. As can be seen there, the core 8 of the cutting area 3 has two conical sections 19 and 20 with different conicity. Starting from the end face 12 of the cutting area 3, a first conical section 19 can be provided, which widens from a diameter corresponding to 0.35 times the cutting area diameter to a diameter corresponding to 0.5 times the cutting area diameter. This first conical section 19 can also extend in the longitudinal direction of the cutting area, i.e., along the axis of rotation 9 over a length of 0.25 times to the entire cutting area diameter. A second conical section 20 can follow this first conical section 19, which widens from the second diameter corresponding to 0.5 times the cutting area diameter to a diameter corresponding to 0.55 times the cutting area diameter. The second conical section 20 can extend in the longitudinal direction of the cutting area over a length corresponding to the cutting area diameter. A limit stop in the form of a blocking groove 21, beginning on the shaft side from the free end of the fastening section 2, can also be provided on the fastening section 2. Concerning formation of the blocking groove 21, reference is made is WO 2007118626 A1, whose content is hereby incorporated herein by reference. An alternative embodiment of the blocking groove could be a Whistle notch or Weldon groove.

FIG. 9 shows a side view of an additional embodiment example of the end mill 1 in the form of a screw-in mill. The end mill 1 differs from the end mill of FIGS. 1 to 8 in that the fastening section 2 is formed partially conical and has thread 22 for screwing into a tool mount (not shown) of a machine spindle. On the free end of the fastening section 2 on the shaft side, an additional support area 23 is also provided. In order to facilitate screwing in of the solid carbide end mill 1, the fastening section 2 has key surfaces 26, which are formed for engagement of the corresponding tool. Concerning this embodiment of the fastening section 2, reference is made to DE 10 2012 100 976 and DE 10 2015 112 079, whose content is hereby included in the application. The other features identical to the embodiment of FIGS. 1 to 8 are provided with the same reference numbers.

FIG. 10 also shows, like FIG. 4, a front view of the free face 12 of the cutting area 3 of the end mill 1, but with different cutting planes.

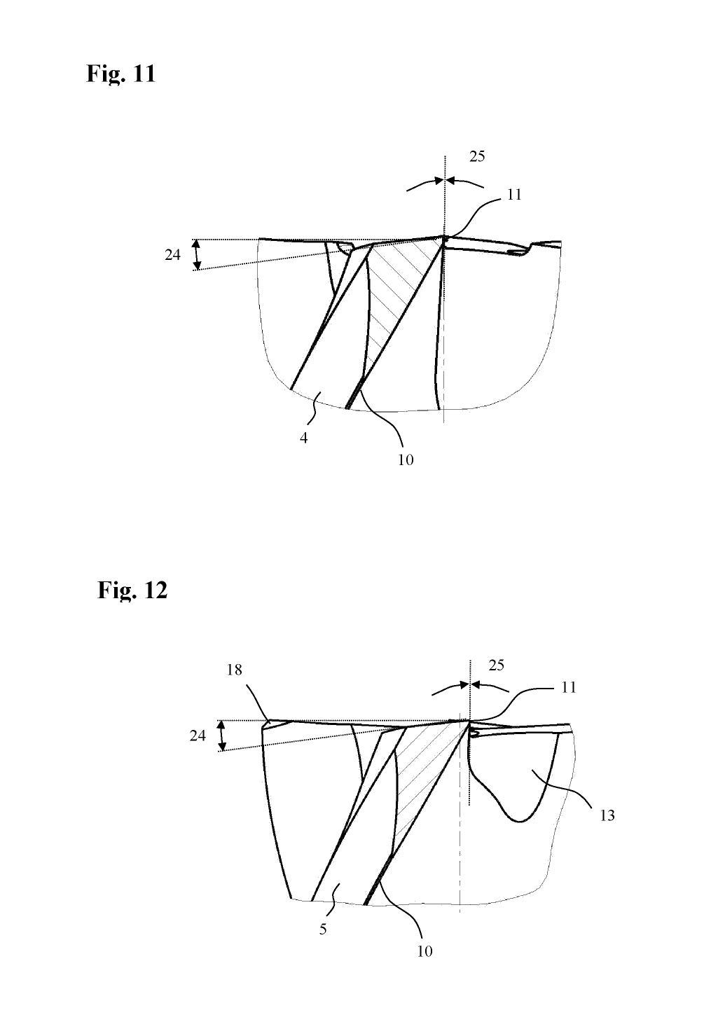

FIGS. 11 and 12 show a cross-sectional view of FIG. 10 along cutting line F-F and G-G. The relief angle 24 and the front rake angle 25 discussed in the description to FIG. 2 but not shown are also readily recognizable here. The front rake angle 25 then amounts to between 3° and −3°, preferably between 1.5° and −1.5°, at most preferably 0°.

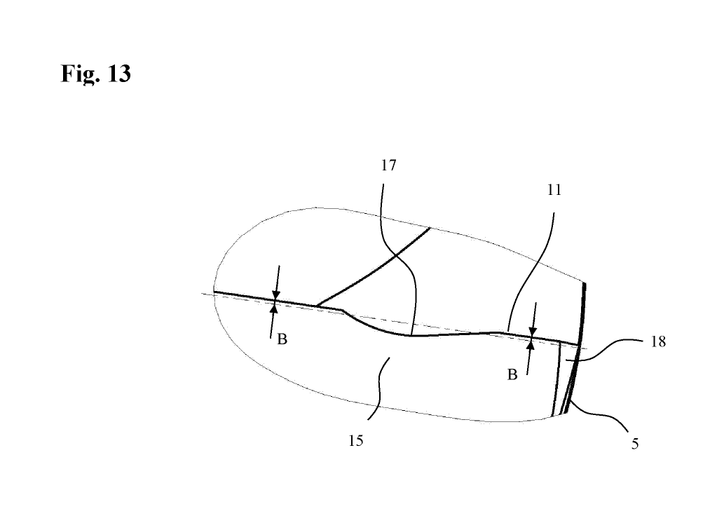

FIG. 13 shows a detail view of X2 of FIG. 10. The protruding center distance B is shown here, in addition to the depiction of FIG. 7.

The technical features described in this embodiment example can be combined individually or in their entirety in order to advantageously solve the problem posed.

### LIST OF REFERENCE NUMBERS

1 Solid carbide end mill

2 Fastening section

3 Cutting area

4 First cutting edge

5 Second cutting edge

6 Third cutting edge

7 Fourth cutting edge

8 Core

9 Axis of rotation

10 Main cutting edge

11 Secondary cutting edge

12 Face of cutting area

13 Point thinning

14 Chip removal grooves

15 Front surface

16 Additional point thinning

17 Bulge

18 Corner chamfer

19 First conical section of core

20 Second conical section of core

21 Blocking groove

22 Threads

23 Additional support area

24 Relief angle

25 Front rake angle

26 Key surface

1. End mill, preferably made of solid carbide, with a fastening section and a cutting area in which the cutting area is formed by a core and three, four or five cutting edges arranged around core running helically around the axis of rotation of end mill, each one of which has a peripheral main cutting edge and a secondary cutting edge on a face of the cutting area, wherein at least one cutting edge on the face of cutting area has a single, flat or continuously curved front surface, which delimits the cutting edge in the longitudinal direction of the end mill on the face.

2. End mill according to claim 1, wherein the front surface of each cutting edge has a relief angle on the secondary cutting edge between 5° and 7°, especially equal to 6° relative a plane perpendicular to the axis of rotation of the end mill.

3. End mill according to claim 1, wherein at least one secondary cutting edge has a curved trend.

4. End mill according to claim 1, wherein at least one secondary cutting edge has a protruding center distance in a radially outer area.

5. End mill according to claim 1, wherein a point thinning of core is provided on the face of cutting area between two adjacent cutting edges, which has an angle from 30° to 40° relative to axis of rotation of end mill.

6. End mill according to claim 5, wherein the point thinning is formed as a recess in the area of face of cutting area that approaches in the direction from the fastening section to the face of cutting area in the direction of axis of rotation of the end mill.

7. End mill according to claim 5, wherein the point thinning extends in the radial direction essentially to the axis of rotation of the end mill and delimits the secondary cutting edge in the area of axis of rotation of the end mill.

8. End mill according to claim 1, wherein the cutting edges are unevenly distributed in the peripheral direction of the end mill.

9. End mill according to claim 1, wherein the cutting area has a total of four cutting edges, of which a first cutting edge and a third cutting edge are diametrically opposite each other, as are a second cutting edge and a fourth cutting edge, and the point thinning is provided between the second cutting edge and the third cutting edge and between the first cutting edge and the fourth cutting edge, in which case, in the peripheral direction of cutting area, the angle between the first cutting edge and the fourth cutting edge and between the second cutting edge and the third cutting edge is greater than 90° and less than 110°, especially equal to 100°.

10. End mill according to claim 9, wherein between the first cutting edge and the second cutting edge and between the third cutting edge and the fourth cutting edge an additional point thinning is provided, which has an angle from 20° to 40° relative to the axis of rotation of the end mill.

11. End mill according to claim 1, wherein the cutting edges have a hollow grinding on the face of cutting area.

12. End mill according to claim 1, wherein the core of cutting area has two conical sections with different conicity.
